(19) United States
(12) Patent Application Publication
(10) Pub. No.: US 2010/0009187 A1
(43) Pub. Date: Jan. 14, 2010

(54) Polycrystalline Corundum Fibers And Method For The Production Thereof

(75) Inventors: Norbert Roesch, Gersthofen (DE); Bernd Clauss, Uhingen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/443,334

(22) PCT Filed: Sep. 8, 2007
(86) PCT No.: PCT/EP2007/007845

§ 371 Date: Mar. 27, 2009

(30) Foreign Application Priority Data
Sep. 28, 2006 (DE) 10 2006 045 816.8

(51) Int. Cl. C04B 35/101; B28B 1/00; B32B 5/02

(52) U.S. Cl. 428/401; 501/127; 264/639

(57) ABSTRACT

The invention relates to polycrystalline corundum fibers substantially consisting of corundum and an oxide of the elements of the main groups I or II of the periodic table. The crystallites of said corundum fibers have the following grain size distribution: 0 to 0.15 micrometers (34%), 0.15 to 0.29 micrometers (55%) and 0.29 to 0.43 micrometers (11%). Said corundum fibers are produced by mixing nuclei and an oxide former of the elements of the main groups I or II of the periodic table with an aluminium chlorohydrate, by adding a water-soluble polymer, then by spinning fibers from said mixture and by calcining said fibers at temperatures above 1100° C.

The present invention relates to novel polycrystalline corundum fibers and a process for their production, which utilizes aluminum chlorohydrate as starting compound.

Ceramic fibers have been produced, and used in different sectors, for many years. They are notable for chemical resistance, thermal stability and remarkable mechanical properties. While short fibers have achieved immense significance in high temperature insulating material as a replacement for asbestos, the filamentary fibers available constitute niche products which, owing to their high cost, are only used in a limited volume, for specialty applications.

As an insulating material, the ceramic fibers based on aluminum oxide and aluminum oxide/silicon dioxide (mullite) find application in oven construction, aerospace and the automotive sector.

These aluminum oxide fibers and mullite fibers are produced using appropriate precursors of the metal oxides as starting materials. Silicon dioxide is frequently used to stabilize the crystal phases and to suppress crystal growth (EP 0 318 203 and EP 0 206 634). Further admixtures to influence crystal structure and crystal growth in the fibers, examples being MgO and iron oxide, are described in EP 0 294 208.

Precursors utilized for producing aluminum oxide and mullite fibers include aluminum salts such as aluminum chlorohydrate (EP 0 318 203) or aluminum formate-acetate mixed salts (EP 0 294 208). U.S. Pat. No. 3 808 015, by contrast, proceeds from mixtures of aluminum oxide particles (13 to 80% fraction) and appropriate binders, for example aluminum chlorohydrate. The aluminum oxide particles used in U.S. Pat. No. 3,808,015 should have a corundum size distribution of 99.5% less than 5 μm, 98% less than 3 μm and 50% greater than 0.2 μm.

Dope rheology and spinnability is frequently improved by admixing water-soluble polymers such as, for example, polyethylene oxide or polyvinyl alcohol.

The present invention accordingly provides polycrystalline corundum fibers consisting essentially of corundum and an oxide of elements of main group I or II of the periodic table wherein the crystallites of these corundum fibers have the following grain size distribution: 0 to 0.15 micrometer (34%), 0.15 to 0.29 micrometer (55%) and 0.29 to 0.43 micrometer (11%). Preference is given to a grain size distribution of 0 to 0.06 micrometer (34%); 0,06 to 0.122 micrometer (55%) and 0.122 to 0.3 micrometer (11%). Having this grain size distribution, the corundum fibers of the present invention differ distinctly from the corundum fibers described in EP 294 208, which according to data reported there have a completely different grain size distribution and a significantly larger particle size.

The corundum fibers of the present invention preferably comprise 0.01% to 20% by weight of an oxide of main group I or II. Such oxides are in particular CaO and MgO.

The present invention further provides a process for producing the corundum fibers described above. This process comprises mixing an aqueous solution of aluminum chlorohydrate with an oxide-former of elements of main groups I and II of the periodic table and crystallization nuclei which promote the formation of α-alumina, admixing this mixture with a water-soluble polymer, spinning fibers and calcining these fibers at temperatures higher than 1100°C.

The aluminum chlorohydrate used has the formula Al₂(OH)ₓCl_{y}, where x is from 2.5 to 5.5, y is from 3.5 to 0.5 and the sum of x and y is always 6. It is preferable to proceed from 50% aqueous solutions, which are commercially available. Such a solution is admixed with crystallization nuclei to promote the formation of the α-form of Al₂O₃. More particularly, such nuclei effect a lowering of the temperature for the formation of the α-form in the subsequent thermal treatment. Useful nuclei preferably include very finely divided corundum, diaspore or hematite. It is particularly preferred to use very finely divided α-Al₂O₃ nuclei having an average particle size of less than 0.1 μm. It is generally sufficient to use 0.1% to 10% by weight of nuclei, based on the aluminum oxide which is formed.

This starting solution further comprises oxide-formers to produce the oxides MeO of the elements of main groups I and II of the periodic table. Useful oxide-formers include in particular the chlorides, especially the chlorides of the elements Ca and Mg, but additionally also other soluble or dispersible salts such as oxides, oxychlorides, carbonates or sulfates. The amount of oxide-former has been determined such that the final fibers contain 0.01% to 20% by weight of the oxide MeO. The oxides of main groups I and II can be present as a separate phase alongside the aluminum oxide or combine with the latter to form genuine mixed oxides such as, for example, spinels etc. The term “mixed oxides” herein is to be understood as including both types.

The aqueous mixture of aluminum chlorohydrate, oxide-formers of elements of main groups I and II and crystallization nuclei has additionally added to it a water-soluble polymer to adjust the rheology for dope spinnability. Useful polymers include polyvinyl alcohols, polyethylene oxides, polyvinylpyrrolidones and other water-soluble, organic polymers, and the polymer content can be in the range 10-40% by weight (based on the oxide content of the mixture). To increase the solids content, it may be advantageous to remove water from the spinnable dope. This can be done by heating at atmospheric pressure or under reduced pressure.

The spinnable dope of the present invention is blown or expressed through dies and the resulting green fibers are collected as short fiber. It is also possible to use the spinnable dope of the present invention to produce long fibers, in which case the filament is taken up and wound on bobbins. The green fiber thus obtained is converted into the desired corundum fiber in a subsequent calcining step. Proceeding from the spinnable dope of the present invention, the formation of α-alumina takes place at temperatures above 1100° C. The fibers thus obtained consist of aluminum oxide to an extent of at least 80% and of α-Al₂O₃ (corundum) to an extent of at least 70%. The average diameter of the corundum crystallites is below 300 nm and the average diameter of all crystallites is below 0.5 μm. Owing to the smallness of the crystallites and their homogeneous distribution, the fibers of the present invention exhibit high tensile moduli and very good mechanical strength combined with retained flexibility.

The long fibers of the present invention are particularly useful for producing ceramic fiber fabrics and as a starting material for producing ceramic matrix and metal matrix composite materials.

### EXAMPLE 1

A 50% aqueous solution of aluminum chlorohydrate was admixed with sufficient magnesium chloride to form a post-calcination ratio of aluminum oxide to magnesium oxide of 99.5:0.5% by weight. In addition, the solution had added to it 2% of crystallization nuclei (based on the oxide content) in the form of a suspension of very fine corundum. After the solution had been homogenized by stirring, an aqueous solution of polyvinylpyrrolidone was added. After being concentrated by evaporative removal of water under reduced pressure, the spinnable dope was dry spun through a multi-hole die. The green fibers obtained were gradually heated to 1100° C. The corundum fiber which formed exhibited corundum crystallites in the range 10-150 nm (scanning electron photomicrographs).

X-ray structural analysis showed the presence of predominantly α-alumina.

1. A polycrystalline corundum fiber consisting essentially of corundum and an oxide of at least one element of main groups I or II of the periodic table, wherein the crystallites of these corundum fibers have the following grain size distribution: 0 to 0.15 micrometer (34%), 0.15 to 0.29 micrometer (55%) and 0.29 to 0.43 micrometer (11%).

2. A polycrystalline corundum fiber consisting essentially of corundum and an oxide of at least one element of main groups I or II of the periodic table, wherein the crystallites of these corundum fibers have the following grain size distribution: 0 to 0.06 micrometer (34%); 0.06 to 0.122 micrometer (55%) and 0.122 to 0.3 micrometer (11%).

3. A polycrystalline corundum fiber according to claim 1 comprising 0.01% to 20% by weight of an oxide of at least one element of groups I or II of the periodic table.

4. A process for producing the polycrystalline corundum fiber of claim 1, which comprises the steps of: admixing an aqueous solution of aluminum chlorohydrate with nuclei and an oxide-former of at least one element of main groups I and II of the periodic table, adding a water-soluble polymer, spinning fibers therefrom and calcining these fibers at temperatures of above 1100° C.

5. The process according to claim 4, wherein the oxide-former comprises chlorides of at least one element of groups I or II of the periodic table.

6. The process according to claim 4, wherein the nuclei comprise very finely divided corundum, diaspore or hematite.

7. The process according to claim 4, wherein 0.1% to 10% by weight of nuclei is added, based on the final corundum fiber.

8. A polycrystalline corundum fiber according to claim 2 comprising 0.01% to 20% by weight of an oxide of at least one element of groups I or II of the periodic table.

9. A process for producing the polycrystalline corundum fiber of claim 2, which comprises the steps of: admixing an aqueous solution of aluminum chlorohydrate with nuclei and an oxide-former of at least one element of main groups I and II of the periodic table, adding a water-soluble polymer, spinning fibers therefrom and calcining these fibers at temperatures of above 1100° C.

10. The process according to claim 9, wherein the oxide-former comprises chlorides of the at least one element of groups I or II of the periodic table.

11. The process according to claim 9, wherein the nuclei comprise very finely divided corundum, diaspore or hematite.

12. The process according to claim 9, wherein 0.1% to 10% by weight of nuclei is added, based on the final corundum fiber.
